(19) United States
(12) Patent Application Publication
(10) Pub. No.: US 2011/0225988 A1
(43) Pub. Date: Sep. 22, 2011

(54) Multi-Lumen Axial Cryogenic Connector

(75) Inventors: John M. Baust, Owego, NY (US); Claudia Lueckge, L'lle-Bizard (CA); Roy Cheeks, Harper's Ferry, WV (US); Melissa K. Dobson, Owego, NY (US); Anthony T. Robilotto, Binghamton, NY (US)

(73) Assignee: CPSI BIOTECH, Owego, NY (US)

(21) Appl. No.: 13/050,055

(22) Filed: Mar. 17, 2011

Related U.S. Application Data
(60) Provisional application No. 61/314,779, filed on Mar. 17, 2010.

(51) Int. Cl. F17C 13/00; F16L 39/00

(52) U.S. Cl. 62/50.7; 285/120.1; 285/123.1; 285/124.1

(57) ABSTRACT

An embodiment of the invention is a cryo-connector, a connector that allows for the delivery and return of a cryogen in an axial configuration. In one embodiment, the connector is a tri-axial configuration allowing for the delivery and return of pressurized cryogen as well as the application of an independent vacuum in the third lumen. Various configurations, however, may accommodate any number of luminary spaces such that cryogen (or other fluids) and/or vacuum spaces may be created in a fashion complementary to the components that the connector will affix to and interconnect with. The connectors can be utilized with any low temperature, cryogenic device and at varying pressures.

The present application claims priority to U.S. Provisional Patent Application No. 61/314,779 filed on Mar. 17, 2010 and titled Multi-Lumen Axial Cryogenic Connector, which is incorporated herein; and also claims priority to U.S. Nonprovisional patent application Ser. No. 13/038,862 filed on Mar. 2, 2011 and titled Cryogenic Medical System which is incorporated herein by reference.

### FIELD OF THE INVENTION

The present invention relates generally to the medical treatment technology field and, in particular, to a device for use in cryo-therapeutic procedures.

### BACKGROUND OF THE INVENTION

Cryotherapy is an effective yet minimally invasive alternative to radical surgery and radiation therapy. In this minimally invasive procedure, the destructive forces of freezing are utilized to ablate unwanted tissue in a way that decreases hospitalization time, reduces postoperative morbidity, decreases return interval to daily activities, and reduces overall treatment cost compared to conventional treatments.

Cryosurgery has been shown to be an effective therapy for a wide range of tumor ablation as well as its use to treat atrial fibrillation. Since the early 1960s, treatment of tumors and unwanted tissue has developed around freezing techniques and new instrumentation and imaging techniques to control the procedure. As a result, the complications of cryoablation have been reduced and the efficacy of the technique has increased.

Improved developments in cryoablation instrumentation have led to the advancement in using cryogenic medical devices. The cryogenic medical devices have been designed to deliver subcooled liquid cryogen to various configurations of cryoprobes for the treatment of damaged, diseased, cancerous or other unwanted tissues. The closed or semi-closed systems allow various cryogens to be contained in both the supply and return stages.

Recently, instrumentation has been discovered to convert liquid nitrogen to supercritical nitrogen (SCN) in a cylinder/cartridge cooled by atmospheric liquid nitrogen (−196° C.), the SCN of which can be subcooled and tuned to the liquid phase, attaining an excess temperature. When the SCN is injected into one or more flexible cryoprobes, the SCN flows with minimal friction to the tip of the probe. In the tip, SCN pressure drops due to an increased volume and outflow restriction, heat is absorbed (nucleate boiling) along the inner surface of the tip, micro bubbles of nitrogen gas condense back into a liquid, and the warmed SCN reverts to pressurized liquid nitrogen as it exits the return tube and resupplies the dewar containing atmospheric liquid nitrogen. This flow dynamic occurs within a few seconds, typically in the order of 1 to 10 seconds depending on the probe or attachment configuration, and is regulated by a high pressure solenoid valve. Further, the cryosurgical procedure once instruments are in place can be performed with freeze times in ranges of about 15 seconds to 5 minutes (or ranges thereof), a drastic improvement over current known methods.

In one prior embodiment of a cryogenic medical device, multiple pressurized cylinders fill and fire in sequence, a heating coil in one or more of the contained pressurized cylinders controlling the pressurization in each cylinder. The device is vented to the surrounding atmosphere through an adjustable pressure vent to prevent excess pressure buildup while in operation. A number of parts including a vacuum insulated outer dewar, submersible cryogen pump, a series of self-pressurizing pulsatile delivery chambers, baffled linear heat exchanger, return chamber, and a series of valves control the flow of the liquid cryogen. As such, connectors are needed to accommodate the delivery and return of cryogen in the system. No connectors are compatible to date that would provide for a coaxial connection in the use of high pressure liquid nitrogen or other high pressure liquid, pseudo- liquid, critical or supercritical cryogens.

In addition, systems include an outer dewar comprising a cryogenic apparatus having pressurizing pulsatile delivery chambers which drive liquid cryogen through the baffled linear heat exchanger. The linear heat exchanger comprises a tube-within-a-tube (i.e. chamber within a chamber configuration) whereby a vacuum is applied to the outer chamber to subcool an isolated reservoir of liquid cryogen. The inner chamber comprises a series of baffles and a central spiral to increase the flow path of the liquid cryogen while providing for increased contact-based surface area with the outer chamber to allow for more effective heat transfer and subcooling of the cryogen being delivered to the probe. Following circulation to the cryoprobe, cryogen (liquid and gas) is returned to the device into a return chamber which surrounds the supply chamber, thereby providing for a staged secondary subcooling chamber for the cryogen in the supply tube. The return chamber is open to the main dewar tank thereby allowing for exchange of liquid and gas between the supply and return chambers. Device operation is controlled and monitored by a series of pressure and vacuum valves designed to control the flow, cooling, and pressurization of the liquid cryogen. This control is achieved through various configurations of manual and computer controlled systems.

Currently, no connectors exist to date which would be compatible with liquid nitrogen under high pressure in an axial (tube-within-a-tube) configuration. No multi-lumen connectors have been developed that would be suitable for use in pressurized liquid cryogenic medical systems. In order to accommodate cryoprobes and cryocatheters that permit the use of cryogens, connectors would preferably have axial configurations (as opposed to side by side tubing). The connectors would also be capable of being miniaturized to allow connections with various catheters, probes, and tubing that are utilized with the current and improved cryogenic systems.

There exists a need for connectors having multiple lumens to enable various portions of the cryo-instrumentation to be interconnected. The multi-lumen connector would be compatible with liquid cryogen under high pressure. In addition, the connectors would desirably be comprised of components that permit interconnection in an axial (tube within a tube) configuration, as demonstrated in embodiments having male and female portions of the connector. The connectors would also be capable of being miniaturized so that various sizes of cryoprobes, catheters and such cryogenic instrumentation may be attachable in a safe manner and for use in the medical environment.

### SUMMARY OF THE INVENTION

An embodiment of the invention is a cryo-connector, a connector that allows for the delivery and return of a cryogen in an axial configuration. In one embodiment, the connector is a tri-axial configuration allowing for the delivery and return of pressurized cryogen as well as the application of an independent vacuum in the third lumen. Various configurations, however, may accommodate any number of luminary spaces such that cryogen (or other fluids) and vacuum spaces may be created in a fashion complementary to the components that the connector will affix to and interconnect.

One embodiment of the invention is a connector for integrating an instrument with a cryoengine, the connector compatible with cryogenic temperatures and pressures, including pressures which exceed the critical point of a cryogen while providing a leak-proof seal, the connector comprising: a first portion having a body and a collar, wherein the body comprises an external surface having one or more connectivity features embedded thereon and an internal configuration having a first channel and a second channel which pass through the body; and a second portion having a mating feature to interconnect with the first portion, the second portion further comprising an inner sleeve including an outerwall with a primary passageway formed therethrough, wherein the inner sleeve is surrounded by an outer sleeve such that a secondary passageway is formed lengthwise along the outer wall of the inner sleeve; wherein the connectivity features of the first portion and the mating feature of the second portion are interconnected such that the first channel of the first portion align with the primary passageway of the second portion and the second channel of the first portion aligns with the secondary passageway of the second portion.

The first portion of the connector comprises a plurality of channels which pass through the body in a side-by-side or axial configuration. The connector further comprises a plurality of sleeves configured axially in a tube-within-a-tube arrangement to provide multiple passageways or lumens lengthwise through the second portion. In one aspect, the plurality of sleeves are configured to have tapered ends to permit various spacing, sizes and dimensions of the multiple passageways. Further, the multiple passageways or lumens interconnect by way of through-holes. The through-holes allow for passage of the cryogen into the secondary passageway, a tertiary passageway, or any of the lumens configured therebetween.

In one embodiment, the connector of claim further comprises umbilical lines which integrate one or more of the connectors in a tri-axial configuration. In one aspect, the first portion is an integral single body. In another aspect, the body includes a collar which may include one or more apertures to secure the first portion to the cryoengine or to the instrument.

In another aspect, a collet interconnects the first portion and the second portion. The second portion or the collet comprises an attachment to adhere to the cryoengine or to the instrument.

One embodiment of the invention utilizes the first portion as a male fitting attached to the cryoengine and the second portion as a female fitting attached to a cryoinstrument, wherein the male fitting interconnects the side-by-side channels with one or more axial configured luminary spaces of the female fitting. The connector integrates electrical and signal communication lines which extend through the first portion and the second portion. The connector is compatible with various pressures and temperatures, including cryogens such as nitrogen, oxygen, hydrogen, carbon dioxide, nitrous oxide, chlorofluorocarbons, or any similar composition.

The connector includes one or more connectivity features which are secure attachments including threaded components, quick-connect components, snap-fit arrangements, sliding parts, adhesives, or quarter turn features, utilized alone or in combination. In one aspect, the sliding parts include a telescoping feature integral with the second portion which provides a secure attachment, such that the sliding parts are extendable and retractable. The telescoping feature may be rigid or may provide flexibility in the secure attachment.

Another aspect of the invention includes a method of delivering a cryogen at cryogenic temperatures through a multi-lumen axial connector, the method comprising the steps of: providing a connector for integrating an instrument with a cryoengine, the connector compatible with cryogenic temperatures and pressures, including pressures which exceed the critical point of a cryogen while providing a leak-proof seal, the connector comprising: a first portion having a body and a collar, wherein the body comprises an external surface having one or more connectivity features embedded thereon and an internal configuration having a first channel and a second channel which pass through the body; and a second portion having a mating feature to interconnect with the first portion, the second portion further comprising an inner sleeve including an outerwall with a primary passageway formed therethrough, wherein the inner sleeve is surrounded by an outer sleeve such that a secondary passageway is formed lengthwise along the outer wall of the inner sleeve; wherein the connectivity features of the first portion and the mating feature of the second portion are interconnected such that the first channel of the first portion align with the primary passageway of the second portion and the second channel of the first portion aligns with the secondary passageway of the second portion; interconnecting the cryoengine and the instrument by engaging the connectivity feature of the first portion with the mating feature of the second portion; and activating the cryoengine to provide a flow of a cryogen through the first channel of the first portion into the primary passageway of the second portion to a distal end of the instrument, wherein the supercritical cryogen changes phase and returns through the secondary passageway of the second portion into the second channel of the first portion.

When a cryogen is utilized in its critical, pseudo-liquid, or supercritical state, the cryogen can be reduced to compressed liquid nitrogen upon its return, such that the connector accommodates the temperature and pressure variations. This allows for the reuse of the liquid cryogen in the cryoengine for continuous treatment procedures.

Further, the step of providing allows for the delivery and the return of a pressurized cryogen, and further comprising a step of applying an independent vacuum in a third channel and tertiary passageway.

When manufacturing the connector, the single or multiple components of the connector (male and female portions) are laid out for assembly. For example, without further limitation, the male portion of the connector is a single shell with tubes inserted through it on the console side to handle the supply, return, and vacuum. On the female side, there are four individual cores which stack inside one another and secured to the male portion via a locking nut. The male or female portions may be manufactured by a single extrusion, or any combination of cores (individual or combined).

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a perspective view of an illustrative embodiment of the device.

FIG. 2 is a perspective view of an illustrative embodiment of the male coupling from FIG. 1.

FIG. 3 is a side-view of an illustrative embodiment of the male coupling from FIG. 2.

FIG. 4 is a cross-sectional view of an illustrative embodiment of the male coupling from FIG. 2 cut along the A-A axis.

FIG. 5 is a perspective view of an illustrative embodiment of the female coupling from FIG. 1.

FIG. 6 is a side-view of an illustrative embodiment of the device from FIG. 5.

FIG. 7 is a cross-sectional view of an illustrative embodiment of the female coupling from FIG. 5.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art that the present invention may be practiced in other embodiments that depart from the specific details disclosed herein. In other instances, detailed descriptions of well-known devices and methods may be omitted so as not to obscure the description of the present invention.

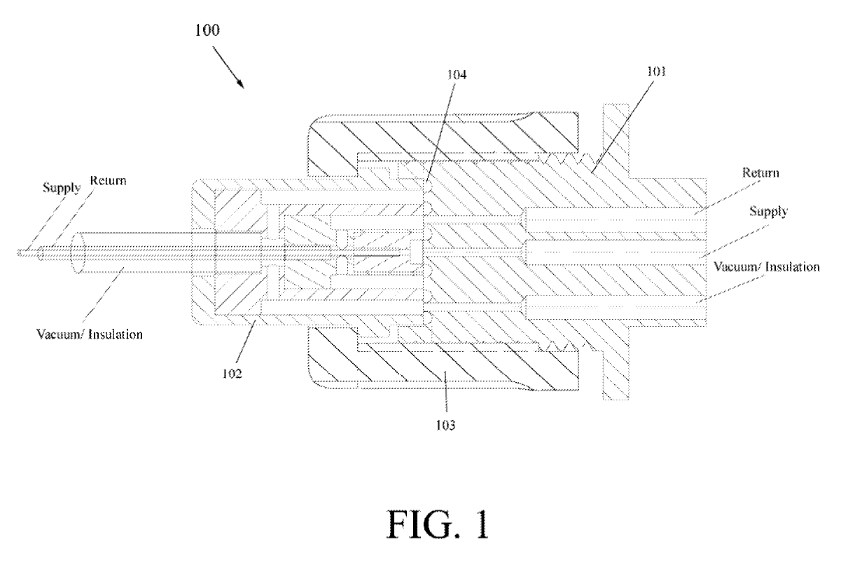

A perspective sideview of a cryo-connector in accordance with one embodiment of the present invention is illustrated in FIG. 1. The integrated device 100 has a first portion 101 which includes the mechanical aspects of a threaded flat screw integrated as a unitary part, such as a male fitting. A second portion 102 is a multi-part integrated piece that forms the female fitting 102 for interconnection with male fitting 101. A collet or holding device 103 securely positions and allows the attachment of the male fitting 101 and female fitting 102. Seals 104 are affixed at the interconnection sites of the male fitting 101 and female fitting 102 to prevent possible leakage of any fluids (gas or liquid) in the connector 100.

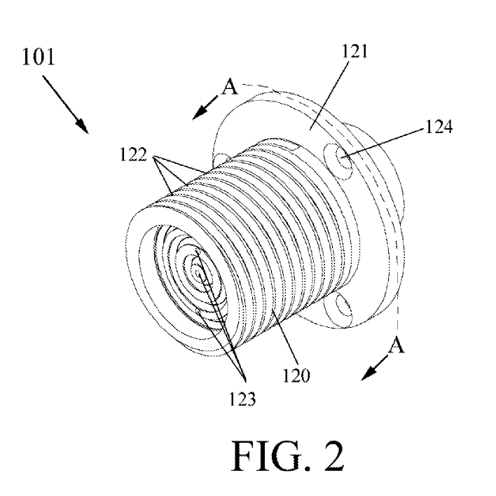

An enlarged perspective view of the male fitting 101 is depicted in FIG. 2. The male fitting 101 is constructed as an integral single body 120 and collar portion 121. The body 120 has threads 122 that interconnect with the collet 103. Interconnecting channels 123 run through the body 120 and collar 121, and the channels 123 vary in diameter as they pass through the body to accommodate the connections with female fitting 102. Apertures 124 on the collar 121 allow the collar to be affixed to a surface on a machine console. The male fitting 101 can be affixed to a cryo-console as fixtures so that female fittings can be attached thereto.

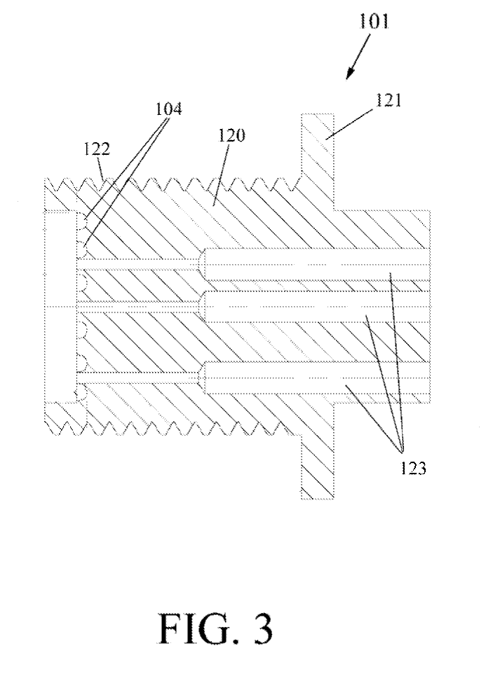

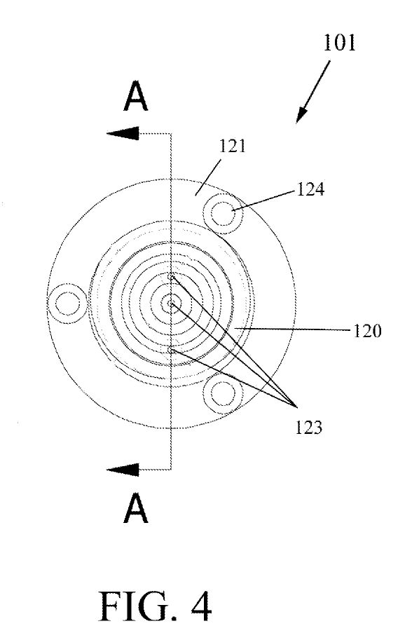

A perspective sideview of the male fitting 101 is illustrated in FIG. 3. In one embodiment, the male fitting 101 has wider interconnection channels at the collar 121 which become narrower as they extend away from the collar to meet with comparably sized channels in the female fitting 102. A cut-away cross-section of the connector (cut along the A-A axis) is illustrated in FIG. 4.

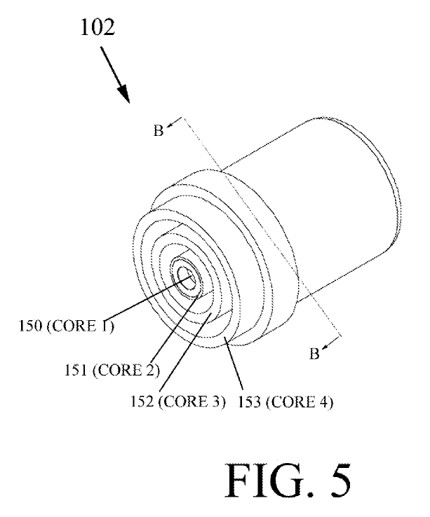

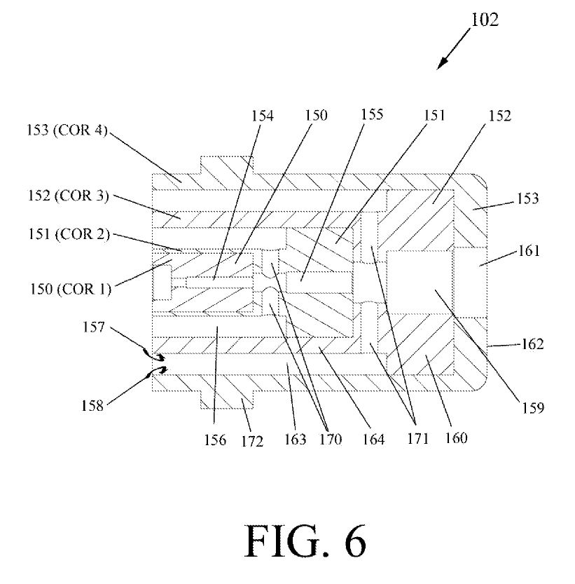

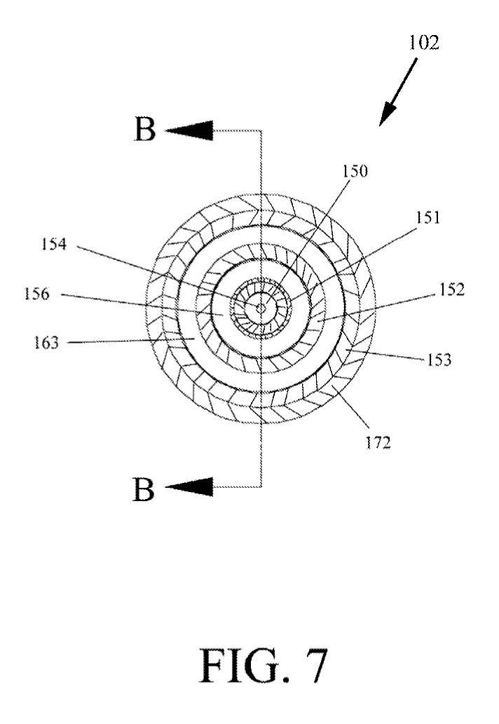

In FIG. 5, a female fitting 102 of one embodiment of the connector 100 is illustrated. A first sleeve (CORE 1) 150 is surrounded by a second sleeve (CORE 2) 151, which is surrounded by a third sleeve (CORE 3) 152 and then a fourth outer sleeve (CORE 4) 153. A perspective sideview of the female fitting 102 is illustrated in FIG. 6. Each sleeve (150, 151, 152, 153) is positioned in a stacking fashion within the outermost sleeve 153 such that channels are formed therebetween and corresponding to the sizes and dimensions of the male fitting 101. As such, the sizes of the channels can be modified by configuring different diameters of the parts and components integrated with each sleeve. In the embodiment of FIG. 6, the inner first sleeve 150 is a plastic supply adapter 150 with a primary channel 154 formed within and running through the length of the sleeve 150. (FIG. 7 illustrates a cross-sectional perspective view of the female fitting 102, the cross-sectional view of which is a cut across the B-B axis of FIG. 5.) The second sleeve 151 is a return adaptor 151 which has a passageway 155 formed therethrough. The second sleeve 151 has a cavity formed at a terminal end where the inner sleeve 150 fits complementary into the pre-molded position. When the second sleeve 151 is positioned with the third sleeve 152, a secondary channel 156 is formed lengthwise alongside the outer wall 157 of the second sleeve 151 and an inner wall 158 of the third sleeve 152. Near the terminal end of the second sleeve 151, a pair of through-holes 170 are drilled to connect with both the passageway 155 and the secondary channel 156. The third sleeve 152 has an enlarged passageway 159 in a terminal end 160 that fits within the fourth sleeve 153. The third sleeve 152 is an insulator adaptor (ring or ferrule) 152 and is configured to have a tapered end 164 to permit different configurations of spacing, sizes and dimensions of the channels. The fourth sleeve 153 is a large cavity which has an aperture 161 formed in an endwall 162. A ring 172 acts as a stop 172 against the collet 103 when the female fitting 102 is attached securely to the male fitting 101. A tertiary channel 163 is formed when the terminal end 160 of the third sleeve 152 fits snugly into the fourth sleeve 153 and thus allows a gap or tertiary channel 163 to be formed at the tapered end 164 of the third sleeve 152. Through-holes 171 are drilled in the third sleeve 152 to allow open passages that connect with the enlarged passageway 159 and with the tertiary channel 163. Here, a vacuum can be pulled throughout the interconnected passages. Any fluid, gaseous or liquid, however, may be utilized in various embodiments of the devices.

Furthermore, the longitudinal continuous channel that is formed by the channels 154, 155, 159, 161 permits multiple attachments to protrude into the channels and affix to the inner surfaces of the apertures. In one embodiment, a larger diameter vacuum tube can be affixed to the walls of the enlarged passageway 159 and aperture 161. Running through the vacuum tube is a smaller diameter return tube that affixes to the walls of the passageway 155 of the second sleeve. An even smaller diameter supply tube, within the dimensions of the return tube, runs the length of the connector from aperture 161 of the fourth sleeve 153 through to the primary channel 154 of the first sleeve 150 where it attaches. Affixing and attaching the tubes may be by any adhesive, gluing, and/or soddering as dependent on the materials utilized and application field.

The interconnection of the four sleeves allows for a continuous channel to be formed when the sleeves are all interconnected (i.e. combination of channels 154, 155, 159, 161). The continuous channel allows for multiple tubes and fixtures to be adjoined to its inner surfaces so that a tube-within-a-tube configuration (each tube carrying different fluids) can be connected to a system where pathways of fluids and fluid delivery systems diverge. The 360° (circular) axial arrangement of the channels in combination with through-holes 170 and 171 allow for passages into the secondary channel 156 and tertiary channel 163, respectively.

In one aspect of the embodiment, the parts and components are plastics adaptable for the use of cryogens. In another aspect, the parts and components may be metals, mixtures of metals, including those well-known for use in the medical industry. Further, any combination of metallic or plastic parts may be utilized to achieve the desired connectivity without leakage of fluids. For exemplary purposes and not limitation, materials utilized have been raw plastics and stainless steel tubing. Appropriate seals and sealing materials are utilized in the connectors for safety and performance in the operation of the cryo-system.

The cryogenic multi-lumen connector 100 is utilized under high pressure at ultra-low temperatures. In one embodiment, the connector is a tri-axial configuration (as illustrated in the accompanying diagrams). In another embodiment, the connector may be comprised of any number of channels and passageways formed therethrough and configured to connect with various consoles, cryo-instruments, and cryo-systems. The cryo-connector allows for the delivery and return of a cryogen, through channel 154 and 156 respectively, while allowing a vacuum to be drawn on the third lumen 163 (tertiary channel 163). The third lumen 163 may be utilized for other types of gas and/or liquid compositions, or for forming a vacuum, as would be compatible with cryoprobes, catheters, and hoses that utilize this functionality. Any number of lumens, however, may be utilized to interconnect with the system chosen. The connector is designed to provide configurations which allow for distinct parallel flowpaths to be integrated in a tube-within-a-tube axial configuration.

In one embodiment, the connector facilitates the quick connection and separation of the two components, male and female fittings. In the use of a medical device, or cryo-console and its disposable probes, the connector may comprise any threaded, quick-connect, snap-on, or ¼ turn configuration to allow easy access and manipulation by a user. Further, designs of the connector allow for easy assembly and parts manufacture. Injection molding or machining of the connector pieces may produce the desired part. Furthermore, molded and integrated parts assembly may provide a mechanism for integrating a telescoping feature internal to the connector. Such a telescoping feature would allow the tubing of the medical devices (such as those with axial tube-within-a-tube configurations) to be easily attached to the connector and retractable. The component could therefore be retracted for connectivity and extended when complete connectivity is achieved for operation of the pressurized system. In one aspect, the telescoping feature is for optimally achieving a secure connection. In another aspect, the feature provides flexibility in the attachment as a safety mechanism for use in pressurized devices and systems.

In another embodiment, the connector may integrate any electrical and/or mechanical connection interface to facilitate monitoring, control, and movement when utilizing the console and probe systems.

As the embodiment described in FIG. 1 describes an axial, tube within a tube, configuration, the male fitting, or male portion, is for attachment to the console. The male portion illustrated has internal channels in a side by side configuration through the body while the female fitting, or female portion, maintains an axial alignment and is attached to the probe or cryoinstrument. The male and female portions align with one another since the open circumferential lumen of the female portion accommodates the flow of cryogen into and away from the channels of the male portion.

The fittings are compatible with the use of cryogens in various phases or states, including liquid, gas, pseudo-fluidic or supercritical states. The cryo-connectors are further compatible with various pressures ranging from about 0 psi to about 1100 psi and above, and temperatures at, above, and well below the critical state of supercritical cryogens, including the critical state of nitrogen. In one embodiment, pressures may range from about 0 psi to about 1200 psi and up to about 6000 psi. Typically, the range includes ambient pressure to about 1500 psi or up to about 3000 psi.

Electrical and signal connections through the channels, passageways, or any other lumens or luminary space continues communication from the distal end of a cryoinstrument (such as a cryoprobe or cryocatheter) to the console and readout device.

Specifically, the connector described herein has cryogen compatibility, including the cryogens of nitrogen, hydrogen, carbon dioxide, nitrous oxide, chlorofluorocarbons and including a subdivision of hydrochlorofluorocarbons (also known as Freon), and other cryogens of a similar nature.

The cryo-connector device may take many forms and be of any size, shape, or dimension. Further, the embodiments of the present invention may be modified to accommodate the size, shape, and dimension of any device or apparatus currently used in the industry. Specifically, connectors utilized to date in cryotherapy may be modified to integrate the multi-lumen channels as thus described. The connectors may also be configured for use alone or in combination with other connectors. Any number or combination of connectors, however, may be integrated in the overall system design. Any number of sensors and/or control mechanisms may also be utilized to facilitate operation at the connection interface on the system or another device.

As presented, the multiple embodiments of the present invention offer several improvements over standard cryo-connection devices currently used in the medical industry. The improved cryogenic medical devices disclosed herein enhance the utilization and interconnection of a cryoprobe or catheter with a cryo-system which freezes targeted tissue. In addition, improvements in the multi-lumen connector design enable construction of the device to enable easy handling, accessibility, and miniaturization.

The invention being thus described, it would be obvious that the same may be varied in many ways by one of ordinary skill in the art having had the benefit of the present disclosure. Such variations are not regarded as a departure from the spirit and scope of the invention, and such modifications as would be obvious to one skilled in the art are intended to be included within the scope of the following claims and their legal equivalents.

1. A connector for integrating an instrument with a cryoengine, the connector compatible with cryogenic temperatures and pressures, including pressures which exceed the critical point of a cryogen while providing a leak-proof seal, the connector comprising:
a first portion having a body and a collar, wherein the body comprises an external surface having one or more connectivity features embedded thereon and an internal configuration having a first channel and a second channel which pass through the body; and
a second portion having a mating feature to interconnect with the first portion, the second portion further comprising an inner sleeve including an outerwall with a primary passageway formed therethrough, wherein the inner sleeve is surrounded by an outer sleeve such that a secondary passageway is formed lengthwise along the outer wall of the inner sleeve;
wherein the connectivity features of the first portion and the mating feature of the second portion are interconnected such that the first channel of the first portion align with the primary passageway of the second portion and the second channel of the first portion aligns with the secondary passageway of the second portion.

2. The connector of claim 1, wherein the first portion comprises a plurality of channels which pass through the body in a side-by-side or axial configuration.

3. The connector of claim 1, further comprising a plurality of sleeves configured axially in a tube-within-a-tube arrangement to provide multiple passageways or lumens lengthwise through the second portion.

4. The connector of claim 3, wherein the plurality of sleeves are configured to have tapered ends to permit various spacing, sizes and dimensions of the multiple passageways

5. The connector of claim 3, wherein the multiple passageways or lumens interconnect by way of through-holes.

6. The connector of claim 5, wherein the through-holes allow for passage of the cryogen into the secondary passageway, a tertiary passageway, or any of the lumens configured therebetween.

7. The connector of claim 1, further comprising umbilical lines which integrate one or more of the connectors in a tri-axial configuration.

8. The connector of claim 1, wherein the first portion is an integral single body.

9. The connector of claim 1, wherein the collar includes one or more apertures to secure the first portion to the cryoengine or to the instrument.

10. The connector of claim 1, further comprising a collet to interconnect the first portion and the second portion.

11. The connector of claim 1, wherein the second portion or a collet comprise an attachment to adhere to the cryoengine or to the instrument.

12. The connector of claim 2, wherein the first portion is a male fitting attached to the cryoengine and the second portion is a female fitting attached to a cryoinstrument, wherein the male fitting interconnects the side-by-side channels with one or more axial configured luminary spaces of the female fitting.

13. The connector of claim 1, further comprising electrical and signal communication lines which extend through the first portion and the second portion.

14. The connector of claim 1, wherein the cryogen is nitrogen, oxygen, hydrogen, carbon dioxide, nitrous oxide, chlorofluorocarbons, or any similar composition.

15. The connector of claim 1, wherein the one or more connectivity features are secure attachments including threaded components, quick-connect components, snap-fit arrangements, sliding parts, adhesives, or quarter turn features, utilized alone or in combination.

16. The connector of claim 1, wherein the sliding parts include a telescoping feature integral with the second portion which provides a secure attachment, such that the sliding parts are extendable and retractable.

17. The connector of claim 15, wherein the telescoping feature provides flexibility in the secure attachment.

18. A method of delivering a cryogen at cryogenic temperatures through a multi-lumen axial connector, the method comprising the steps of:
providing a connector for integrating an instrument with a cryoengine, the connector compatible with cryogenic temperatures and pressures, including pressures which exceed the critical point of a cryogen while providing a leak-proof seal, the connector comprising: a first portion having a body and a collar, wherein the body comprises an external surface having one or more connectivity features embedded thereon and an internal configuration having a first channel and a second channel which pass through the body; and a second portion having a mating feature to interconnect with the first portion, the second portion further comprising an inner sleeve including an outerwall with a primary passageway formed therethrough, wherein the inner sleeve is surrounded by an outer sleeve such that a secondary passageway is formed lengthwise along the outer wall of the inner sleeve; wherein the connectivity features of the first portion and the mating feature of the second portion are interconnected such that the first channel of the first portion align with the primary passageway of the second portion and the second channel of the first portion aligns with the secondary passageway of the second portion;
interconnecting the cryoengine and the instrument by engaging the connectivity feature of the first portion with the mating feature of the second portion; and
activating the cryoengine to provide a flow of a cryogen through the first channel of the first portion into the primary passageway of the second portion to a distal end of the instrument, wherein the supercritical cryogen changes phase and returns through the secondary passageway of the second portion into the second channel of the first portion.

19. The method of claim 18, wherein the cryogen is reduced to compressed liquid nitrogen and is reused in the cryoengine for continuous treatment procedures.

20. The method of claim 18, wherein the step of providing allows for the delivery and the return of a pressurized cryogen, and further comprising a step of applying an independent vacuum in a third channel and tertiary passageway.
